(19) United States
(12) Patent Application Publication
(10) Pub. No.: US 2008/0133574 A1
(43) Pub. Date: Jun. 5, 2008

(54) METHOD, PROGRAM AND DEVICE FOR RETRIEVING SYMBOL STRINGS, AND METHOD, PROGRAM AND DEVICE FOR GENERATING TRIE THEREOF

(76) Inventors: Taiga Fukushima, Fujisawa (JP); Yasuhiro Tahara, Hiratsuka (JP); Naoki Inoue, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/861,670

(22) Filed: Sep. 26, 2007

(30) Foreign Application Priority Data
Nov. 27, 2006 (JP) 2006-318460

(51) Int. Cl. G06F 17/30

(52) U.S. Cl. 707/102; 707/E17.044

(57) ABSTRACT

Even an instrument with a small memory capacity realizes fast document retrieval through the use of a trie. A computer generates an index layered node by grouping the nodes in the trie as a family with relation to a parent node and layers the first and second tries with the index layered node as a border. The first trie is stored in a storage area of a main storage unit. The second trie is stored in a storage area of a secondary storage unit. When the computer accepts an input of a term to be retrieved, in the first and the second tries, the computer traces characters of a character string composing the term to be retrieved and then reaches the index information for the concerned character string. The computer reads the index information and retrieves a document having the term to be retrieved and a location of the document.

### INCORPORATION BY REFERENCE

The present application claims priority from Japanese application JP2006-318460 filed on Nov. 27, 2006, the content of which is hereby incorporated by reference into this application.

### BACKGROUND OF THE INVENTION

The present invention relates to a technology of generating a retrieval index to be used for a document retrieving system.

As one of the conventional technologies of enabling a computer to retrieve a document including a designated character string to be retrieved at fast speed, there has been known the index-based technology (referred to as the first system). The index, termed in the first system, includes (1) an index item that designates a keyword in a document to be retrieved and (2) document identification information that identifies a document having the index item and index information that designates a location of the index item in the concerned document. Further, like the first system, in the document retrieving method configured to use the index, the index items of the documents are managed in a tree structure often called a trie.

This trie means a tree structure generated by selectively grouping a partial character string to each keyword (referred simply to as a key) included in a set of character strings, that is, keywords to be retrieved (the set being referred to as a key set) as a common node. This trie is used for retrieving an index. A concerned computer operates to decompose the character string of a term to be retrieved into keys and trace the nodes with the key in the trie. When the computer trace reaches the last node of the trie, the computer enables to read pointer information set to the last node and then read the index information for the term to be retrieved on the basis of the pointer information.

The summary of this trie will be described with reference to FIG. 1. FIG. 1 illustrates an index of the cited reference. As described above, the index 105 includes a trie 100, which is composed of index items arranged in the tree structure, and index information 101 for the index items. In addition, pointer information 102 to be used for reading the index information 101 is set to a node of a final character string of this trie 100.

The trie 100 shown in FIG. 1 is a three-gram trie in which the key has three characters. In the shown trie, the character string starts from [symbol] (a). The character string is a romanized Japanese word. For example, in this trie, the nodes of [symbol] (a)”, [symbol] (i)”, “ [symbol] (u)”, . . . , [symbol] (n)” are set as the two-gram nodes following the one-gram node of [symbol] (a)”. Then, as the next three-gram nodes, the nodes of [symbol] (a)”, . . . , [symbol] (n) are set. Finally, the pointer information 102 to be used for reading the index information 101 is set to the last node (that is, the three-gram node in FIG. 1).

Herein, when the concerned computer retrieves a document number of a document having a character string of [symbol] (a-i-ti)” and a character location in the document along this trie 100, the computer executes the following operation.

At first, the computer traces the one-gram node of [symbol] (a)”, then, the two-gram node of [symbol] (i)” following the one-gram node, and then the three-gram node of [symbol] (ti)” following the two-gram node. Next, the computer reads the index information 101 about [symbol] (a-i-ti)” from a predetermined area of a storage area by referring to the pointer information item 102 (ptr61) set to the last node of [symbol] (ti)”. That is, the computer reads a document number (document identification information) 103 of a document having [symbol] [symbol] (a-i-ti)”, that is, “001”, and a character location 104 of [symbol] (a-i-ti)” in the document, that is, “21”.

In the following description, the terms “pointer information 102” and “index information 101” are often referred to as the “pointer information item(s) 102” and the “index information item(s) 101”, each of which is connected with each node.

The foregoing operation is disclosed in JP-A-11-143901 and JP-A-59-148922.

### SUMMARY OF THE INVENTION

In order to make the retrieval of the index information of the document faster when the computer manages the indexes with the foregoing tries, it is possible to make the size of each index information item and the number of grams (character number of a common partial character string (symbol string) to each key) in each trie greater. However, if the trie has such a greater number of grams, the trie may be overflown from a memory capacity. This shortcoming becomes a great obstacle especially when mounting a document retrieving system to an instrument with a small memory capacity such as a portable phone or a DVD (Digital Versatile Disk) player.

It is therefore an object of the present invention to overcome the foregoing shortcoming and provide a method and a device which are arranged to realize a fast document retrieval along a trie even if the method and the device are applied to an instrument with a small memory capacity.

In carrying out the foregoing object, according to an aspect of the invention, at first, a computer (device for retrieving a symbol string) provided with a main storage unit and a secondary storage unit operates to generate a trie. Then, the computer calculates a total of required retrieval times of index information items connected with the nodes composing the generated trie by referring to the required retrieval time of the index information retrieved along the trie. Next, the computer determines if the calculated required retrieval time of each node is equal to or less than a predetermined threshold value. Herein, the computer generates an index layered node by grouping the nodes as a family with relation to the same parent node, selectively from the nodes each required retrieval time of which is equal to or less than the predetermined threshold value. That is, those nodes are grouped as a family with relation to the same parent node. Then, the first trie is generated by replacing the nodes to be grouped and the nodes following the former nodes. This generated first trie is stored in a predetermined area of the main storage unit. The nodes to be grouped and the nodes following the former nodes are moved as a second trie to a predetermined area of the secondary storage unit. Then, the pointer information that designates the storage area of the second trie is set to the index layered node of the first trie. This arrangement allows the computer to trace the first trie stored in the main storage unit and then to access the second trie stored in the secondary storage unit when the computer retrieves the index information by referring to a symbol string (including a character string) included in the term to be retrieved. In addition, the symbol string means connection of symbols of symbol codes generated by dividing a one-byte character code or a two-byte character code into two bits or four bits.

As described above, the symbol string retrieving device according to one aspect of the invention operates to keep the trie layered as the first trie and the second trie and store them in the main storage unit and the second storage unit respectively. Hence, if the instrument (such as a computer) has a small main storage unit (such as a memory) capacity, the trie of a large size may be provided in the instrument. That is, the symbol string retrieving device enables to retrieve a document along the tire at fast speed. Further, when generating the first trie, the symbol string retrieving device keeps the nodes in the first trie grouped as a family with relation to the parent node. Hence, the nodes of the first trie stored in the main storage unit may be reduced in number. That is, the reduction of the size of the first trie allows even the computer with a small main storage unit (such as a memory) capacity to be more easily provided in the trie. Moreover, in the first trie, the nodes to be grouped as a family with relation to the parent node are restricted to the nodes following the former nodes, in which the total of the required retrieval times of the index information items is equal to or less than the predetermined threshold value. That is, as to the nodes following the former nodes in which the total of the required retrieval times of the index information items is more than the threshold value, the symbol string retrieving device enable to immediately reach the index information without through the second trie. This arrangement makes it possible to improve the retrieval efficiency of the retrieval information with the trie.

According to the present invention, even the instrument with a small memory capacity enables to retrieve a document at fast speed along the tire.

The other objects and methods of achieving the objects will be readily understood in conjunction with the description of embodiments of the present invention and the drawings.

Other objects, features and advantages of the invention will become apparent from the following description of the embodiments of the invention taken in conjunction with the accompanying drawings.

### BRIEF DESCRIPTION OF THE DRAWINGS

FIG. 1 shows a conventional index;

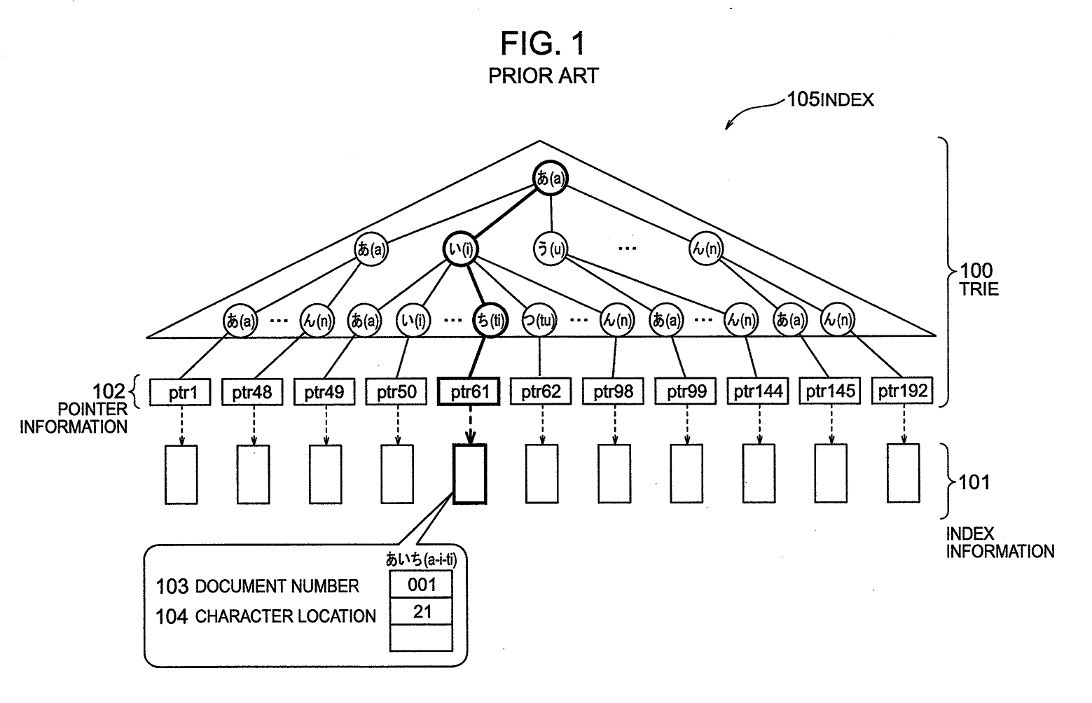

FIG. 2 is a diagram showing an arrangement of a document registering and retrieving system according to a first embodiment of the present invention;

FIG. 3 is a flowchart showing a process of an index generating and registering program included in the system shown in FIG. 2;

FIG. 4 is a flowchart showing a procedure of a trie initializing program included in the system shown in FIG. 2;

FIG. 5 shows an index including a trie generated under the trie initializing program controlled by the CPU of FIG. 2;

FIG. 6 is a flowchart showing a procedure of an index layering program included in the system shown in FIG. 2;

FIG. 7 is a flowchart showing a procedure of the index layering program included in the system shown in FIG. 2;

FIG. 8 is a flowchart showing a procedure of an index layered node generating program included in the system shown in FIG. 2;

FIG. 9 illustrates a trie generated on the trie shown in FIG. 5;

FIG. 10 is a flowchart showing a procedure of an index layered node dividing program included in the system shown in FIG. 2;

FIG. 11 is an explanatory view conceptually showing a procedure of dividing the index layered node included in the first embodiment of the present invention;

FIG. 12 is an explanatory view conceptually showing a procedure of dividing the index layered node included in the first embodiment of the present invention;

FIGS. 13A and 13B are views cited for explaining FIGS. 11 and 12;

FIG. 14 is a flowchart showing a procedure of the index retrieving program included in the system shown in FIG. 2;

FIG. 15 is a diagram showing an exemplary arrangement of a document registering and retrieving system according to a second embodiment of the invention;

FIG. 16 is a flowchart showing a procedure of the index layering program shown in FIG. 15;

FIG. 17 is a flowchart showing a procedure of the index layering program shown in FIG. 15;

FIG. 18 illustrates an index included in the second embodiment of the invention; and

FIG. 19 illustrates a layered arrangement of the index shown in FIG. 18.

### DETAILED DESCRIPTION OF THE EMBODIMENTS

Hereafter, the best modes of carrying out the present invention (referred to as the embodiments) will be described with reference to the appended drawings.

### First Embodiment

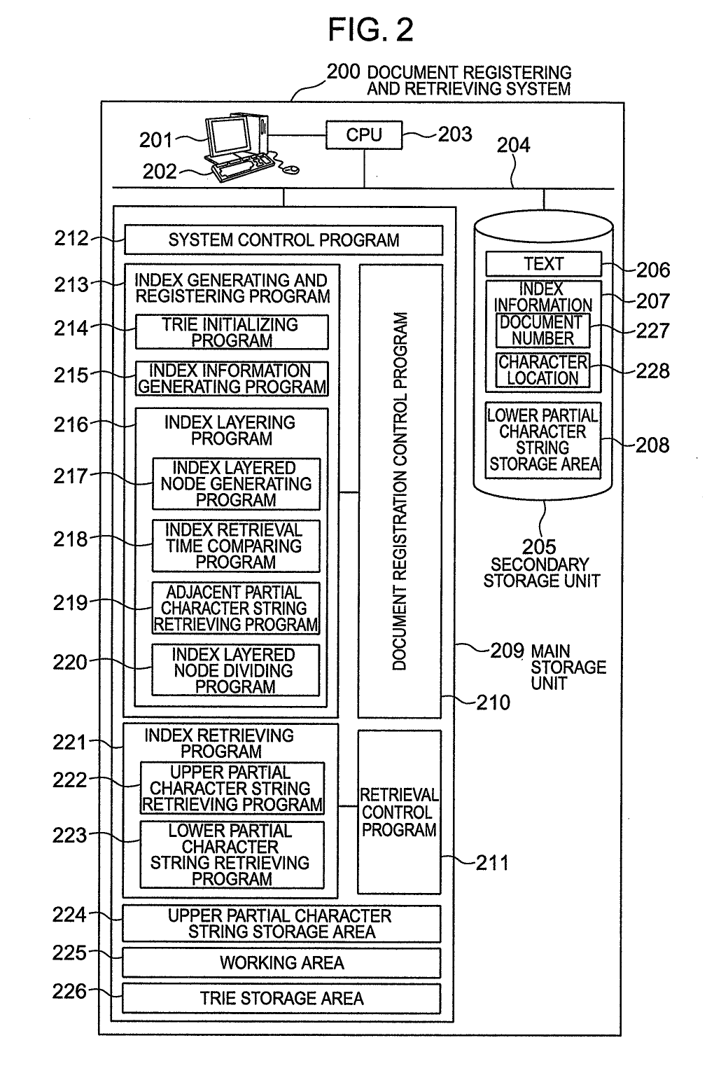

FIG. 2 shows an exemplary arrangement of a document registering and retrieving system according to the first embodiment of the present invention.

As shown in FIG. 2, the document registering and retrieving system (composed of a trie generating device and a symbol string retrieving device) 200 is arranged to have a display 201, a keyboard 202, a CPU (Central Processing Unit) 203, a main storage unit 209, a secondary storage unit 205, and a bus 204 for connecting those components.

The display (or an output unit) 201 displays the retrieved result supplied by the CPU 203. The keyboard (or an input unit) 202 is used for inputting commands for registering and retrieving text 206 and a term to be retrieved (often referred to as a retrieval term). The CPU 203 executed the programs to be discussed below. Those programs are executed to register an index and retrieve a keyboard to be retrieved. The main storage unit 209 temporarily stores the programs for registering and retrieving an index, data to be inputted or outputted, and so forth. The secondary storage unit 205 stores the data and the programs.

The secondary storage unit 205 is provided with a disk cache (not shown). This disk cache is used for copying part of data recorded on a storage unit with a slow access speed like a harddisk drive so that the read of the data may be made faster. This disk cache is composed of a semiconductor memory like a RAM (Random Access Memory) included in the secondary storage unit 205. Further, the main storage unit 209 is also composed of the semiconductor memory like a RAM. The secondary storage unit 205 is composed of a harddisk drive (HDD) or a flash memory.

The secondary storage unit 205 stores a system control program 212 that controls the overall system 200, a document registration control program 210 and an index creation registering program 213, both of which are functioned as a registration program, and a retrieval control program 211 and an index retrieving program 221, both of which are functioned as the retrieving program. Those programs are read out to the main storage unit 209 and executed under the control of the CPU 203. FIG. 2 shows the state where those programs are read out to the main storage unit 209. The main storage unit 209 includes a working area 225 for temporarily storing the data, an upper partial character string storage area 224, and a trie storage area 226, all of which are secured in the unit 209.

Herein, the summary of each of the foregoing programs will be descried below.

The system control program 212 controls an input and output to be executed by a user through the display 201 and the keyboard 202. Further, the program 212 controls the execution of the other programs as well.

The document registration control program 210 is a program that controls the index generating and registering program 213.

The index generating and registering program 213 is arranged to have a trie initializing program 214, an index information generating program 215, and an index layering program 216. The trie initializing program 214 is a program which initializes trie(s). The execution of this trie initializing program 214 through the CPU 203 leads to the realization of the function of the trie initializing unit claimed in a claim. The index information generating program 215 is a program that generates the index information 207 (to be discussed below). The index layering program 216 is a program that layers the index, that is, divides the trie into two layers.

This index layering program 216 is arranged to have an index layered node generating program 217, an index retrieval time comparing program 218, an adjacent partial character string retrieving program 219, and an index layered node dividing program 220.

The index layered node generating program 217 is a program that generates an index layered node (to be discussed later in detail). The execution of the index layered node generating program 217 through the CPU 203 leads to the realization of the function of an index layered node generating unit claimed in a claim.

The index layered node generating program 218 is a program that compares the required retrieval time of the index information 207 with a target retrieval time (to be discussed later in detail). The execution of the index retrieval time comparing program 218 through the CPU 203 leads to the realization of the function of the index retrieval time comparator claimed in a claim.

The adjacent character string retrieving program 219 is a program that searches the nodes having the same parent node (that is, the twin nodes) in the trie. The execution of the adjacent partial character string retrieving program 219 through the CPU 203 leads to the realization of the function of the adjacent partial symbol string retrieving unit claimed in a claim.

The index layered node dividing program 220 is a program that divides the index layered node if the size of the lower trie (the second trie) of the layered tries exceeds the predetermined threshold value.

Further, the index retrieving program 221 is composed of an upper character string retrieving program 222 and a lower partial character string retrieving program 223. The upper partial character string retrieving program 222 is a program that retrieves the upper trie (the first trie) of the layered tries. The lower character string retrieving program 223 is a program that retrieves the lower trie (the second trie) of the layered tries. The execution of the index retrieving program 221 through the CPU 203 leads to the realization of the function of the index retrieving unit claimed in a claim.

The secondary storage unit 205 stores the text 206 that is the document data and the index information 207 of the text 206. Further, a lower partial character string storage area 208 for storing the second trie is secured in the secondary storage unit 205.

The details of the foregoing programs will be set forth in the sections of describing the registering process and the retrieving process included in this embodiment.

### (Registering Process)

The process for registering the document data (the text 206) inputted by the user is executed by the document registration control program 210, which is executed by the system control program 212 run by the CPU 203.

### (Index Generating and Registering Program)

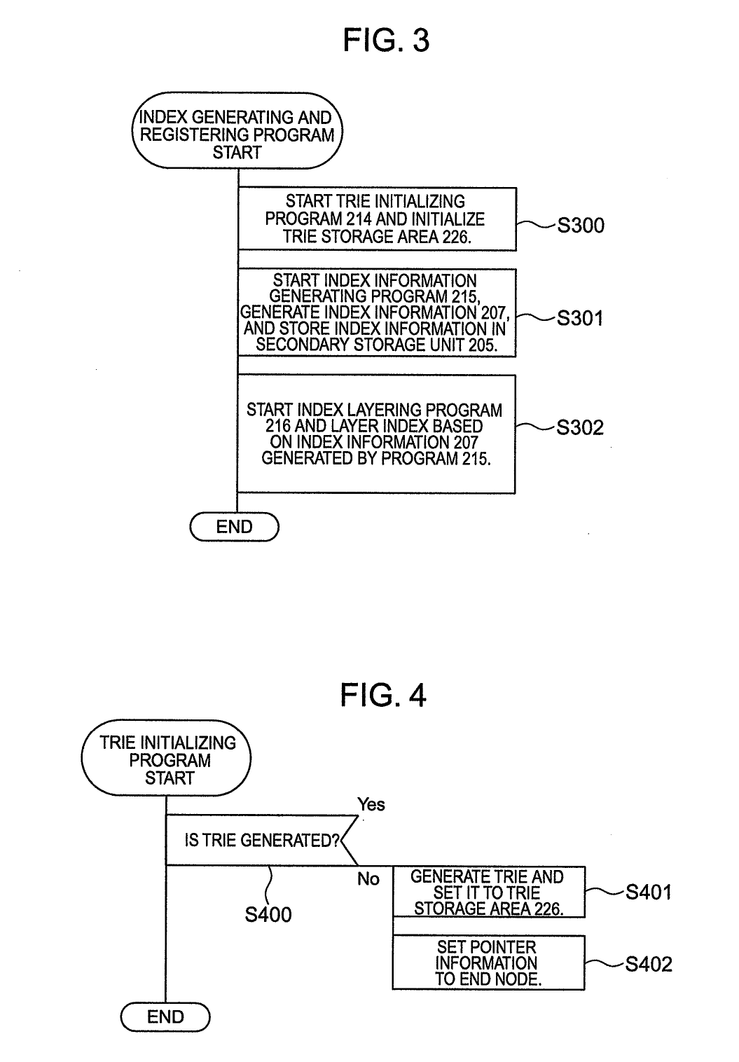

In turn, the index generating and registering program 213 will be described by using the PAD (Program Analysis Diagram) shown in FIG. 3 with reference to FIG. 2. FIG. 3 illustrates the procedure of the index generating and registering program shown in FIG. 2.

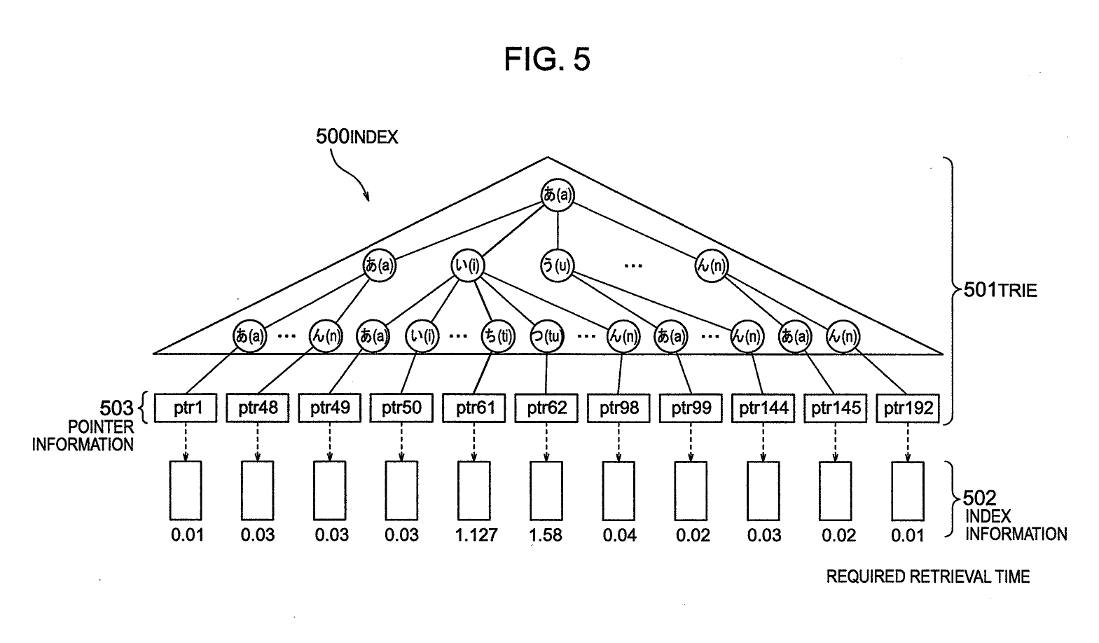

At first, the CPU 203 shown in FIG. 2 starts the trie initializing program 214 so that the program 214 initializes the trie storage area 226 (S300). The initialization to be executed by the trie initializing program 214 will be described later in detail with reference to FIG. 4.

Next, the CPU 203 starts the index information generating program 215 so that the program 215 generates the index information 207 and stores the index information 207 in the secondary storage unit 205 (S301). In particular, the CPU 203 extracts from the text 206 stored in the secondary storage unit 205 a predetermined partial character string, a document number (a document identification information) 227 belonging to the text 206, and its character location (appearing location information) 228, generates the index information 207, and then stores the index information 207 in the secondary storage unit 205.

For example, the CPU 203 starts the index information generating program 215. The program 215 is executed to generate from the text 206 of “ . . . . [symbol] (a-i-ti) . . . ” of the document number “001” the index information item 207 that designates the character string of [symbol] (a-i-ti)” is included in the document of the document number “001” and “21” is the character location of the head character [symbol] (a)” of the character string [symbol] (a-i-ti)” in the document. Then, the program is also executed to store the generated index information item 207 in the secondary storage unit 205. Further, the CPU 203 measures the retrieval time required for retrieving the index information item 207 (required retrieval time) with respect to each index information item 207 and then adds the required retrieval time to the corresponding index information item 207.

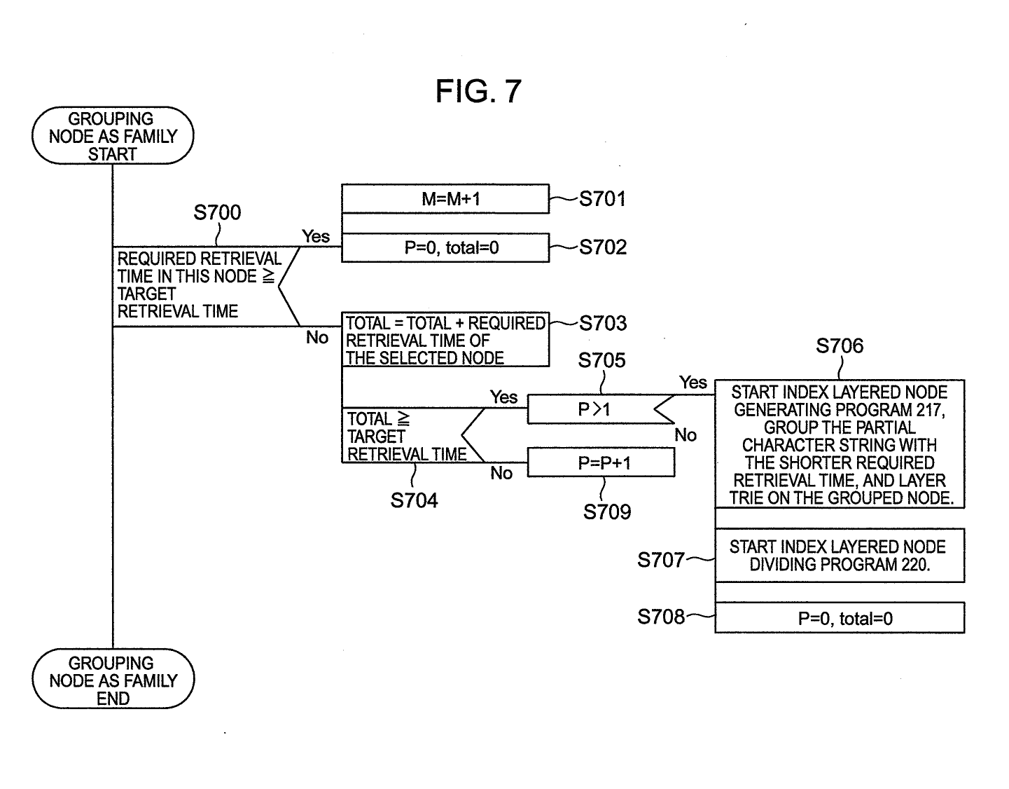

Next, the CPU 203 starts the index layering program 216. Then, the CPU 203 executes the process for layering the index on the basis of the index information 207 generated by the index information generating program 215 (S302). This process for layering the index will be described later in detail with reference to FIG. 6.

### (Trie Initializing Program)

In turn, the trie initializing program 214 will be described in detail by using the PAD shown in FIG. 4 with reference to FIG. 2. FIG. 4 illustrates the procedure of the trie initializing program shown in FIG. 2.

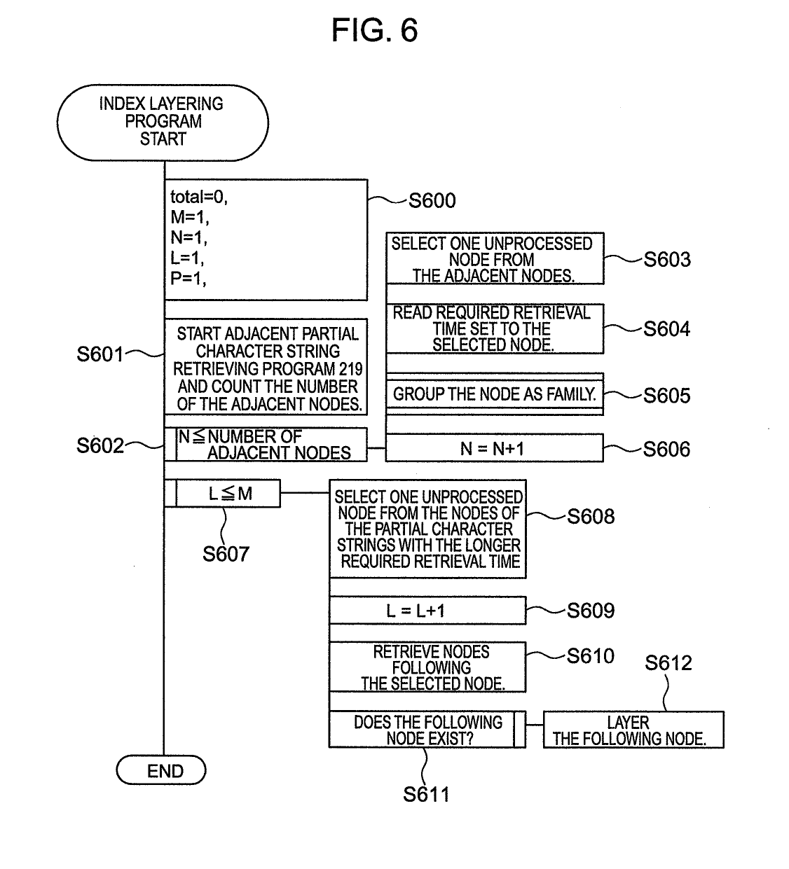

At first, the CPU 203 shown in FIG. 2 determines if the trie has been already generated and the trie storage area 226 is secured in the main storage unit 209 (S400). If the trie has not been generated yet and the trie storage area 226 has not been secured in the main storage unit 209 (No in S400), the CPU 203 divides all the characters used in the text 206 into the character strings of the gram number (for example, 3 grams). For example, if the character string of [symbol] (a-i-ti-ha-ku)” is included, the CPU 203 divides this character string into the character string of three grams [symbol] (a-i-ti)” and the remaining character string [symbol] (ha-ku)”. “_” denotes a blank. Then, the CPU 203 generates the trie with one character of the divided character string as a key (node) and secures the trie storage area 226 (S401). For example, the CPU 203 generates the trie in which [symbol] (a)” is set to the one-gram node, [symbol] (i)” is set to the two-gram node, and [symbol] (ti)” is set to the three-gram node and then stores the trie in the trie storage area 226. The concrete example of the trie generated by the CPU 203 at this time will be described later with reference to FIG. 5.

Then, the CPU 203 sets to each last node of the trie the pointer information of the index information item 207 corresponding with the character string (S402).

Herein, the trie generated by the trie initializing program 214 operated by the CPU 203 will be described with reference to FIG. 5. FIG. 5 illustrates the index having the tire generated by the trie initializing program run by the CPU shown in FIG. 2.

As illustrated in FIG. 5, the index 500 is composed of a trie 501, in which the index items are arranged in the tree structure, and index information items 502 corresponding with the index items. The pointer information items 503 to be used for reading the index information items are set to the last node of the character string in the trie 501. In FIG. 5 is shown only the trie of the character string starting from [symbol] (a)”. In addition to this, the trie of the character string starting from [symbol] (i)” and the trie of the character string starting from [symbol] (u)” are also provided.

For example, in the trie 501 shown in FIG. 5, the nodes [symbol] (a)”, [symbol] (i)”, [symbol] (u)”, . . . , [symbol] (n) “are set to the two-gram node following the one-gram [symbol] (a)”. Then, the nodes [symbol] (a), . . . , [symbol] (n)” are set to the following three-gram node. Finally, the pointer information items 503 to be used for reading the index information items 502 are set to the last node (the three-gram node shown in FIG. 5). For example, the pointer information item 503 for the index information item 207 about [symbol] (a-i-ti)” corresponds to “prt61” and the required retrieval time of this index information item 207 is “1.127”.

Though the description is left out in FIG. 5, the CPU 203 presets the required retrieval time of each index information item 207 connected with each of the nodes composing the trie when the trie is initialized.

In this pre-setting, the CPU 203 sets the required retrieval time of the index information item 207 connected with the last node to the last node of the trie 501 (for example, the three-gram node of the trie shown in FIG. 5). At a time, the CPU 203 sets the total value of the required retrieval time set to the nodes connected with the last node to the other nodes rather than the last node of the trie 501.

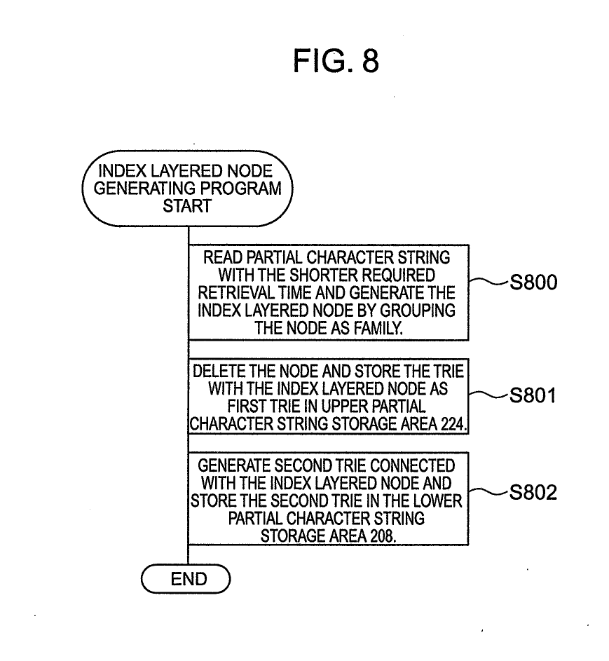

For example, consider the case that the nodes of [symbol] (a)” to [symbol] (n)” are connected as the three-gram node with the two-gram node of [symbol] (a)” in the trie 501 shown in FIG. 5. In this case, the CPU 203 sets the total value of the required retrieval times of the three-gram nodes of [symbol] (a)” to [symbol] (n)” as the required retrieval time of the two-gram node of [symbol] (a)”. Likewise, to set the required retrieval time of the one-gram node of [symbol] (a)”, the CPU 203 sets the total value of the required retrieval times set to the two-gram nodes of [symbol] (a)” to [symbol] (n)”. As such, the CPU 203 calculates the total values of the required retrieval times of the index information items 207 sequentially from the end node to the one-gram node in the trie 501 and sets the calculated value to the corresponding node. The required retrieval time set to each node is referenced when the CPU 203 groups the nodes of the trie as a family with relation to a parent node and layers them. The details of the process for grouping the nodes as a family with relation to the parent node and layering them will be described later with reference to FIGS. 6 and 7.

Though in FIG. 5 the trie 501 is started from the one-gram node of [symbol] (a)”, another trie is started from the one-gram node of [symbol] (i)” to [symbol] (wa)” and is stored in the trie storage area 226. Further, though not shown, the 0-gram node is set as the parent node of the one-gram node. In this arrangement, when the CPU 203 retrieves the nodes adjacent to the one-gram node of [symbol] (a)”, the one-gram nodes of [symbol] (i)” to [symbol] (wa)” are retrieved.

### (Index Layering Program And Index Retrieval Time Comparing Program)

In turn, the index layering program 216 and the index retrieval time comparing program 218 will be described in detail with the PAD shown in FIGS. 6 and 7 with reference to FIG. 2. FIGS. 6 and 7 show the procedure of the index layering program shown in FIG. 2.

At first, the CPU 203 operates to read the trie generated by the trie initializing program 214 from the trie storage area 226 of the main storage unit 209. At a time, the CPU 203 sets initial values of variables (total, M, N, L, P) to be used for running the index layering program 216. Herein, the CPU 203 sets total=0, M=1, N=1, L=1, and P=1 as the initial values (S600).

This variable “total” is used for calculating a total value of the required retrieval times set to the nodes of the trie. The variable “M” is used for counting the number of the nodes each required retrieval time of which is equal to or more than the target retrieval time (which will be simply referred to as the nodes of the longer required retrieval time). The variable “N” is used for counting the number of processed adjacent nodes. The variable “L” is used for counting the number of processed nodes each required retrieval time of which is less than the target retrieval time (which will be simply referred to as the nodes of the shorter required retrieval time). The variable “P” is used by the variable “total” for counting the number of the nodes of the shorter required retrieval time. The target retrieval time is a threshold value to be used so that the CPU 203 may determine if the concerned node is grouped as a family with relation to a parent node. This target retrieval time is stored in the predetermined area of the main storage unit 209.

Next, the CPU 203 starts the adjacent partial character string retrieving program 219. The program 219 is executed to search the adjacent nodes and count the number of the nodes (S601). At first, the CPU 203 counts the number of the one-gram nodes in the trie. That is, the CPU 203 counts the number of twin nodes with the 0-gram node (not shown) of the trie as a parent node. For example, the CPU 203 counts the one-gram node of [symbol] (a)” in the trie shown in FIG. 5 and the one-gram nodes of [symbol] (i)” to [symbol] (wa)” in the trie (not shown in FIG. 5).

Then, the CPU 203 determines if the value of the variable “N” is equal to or less than the value counted in the step S601 (S602). If the CPU 203 determines that it is in the step S601, the CPU goes to a step S603.

Next, the CPU 203 selects one of the adjacent nodes which have not been processed yet (S603). For example, the unprocessed node of [symbol] (a)” is selected from the one-gram nodes of [symbol] (a)” to [symbol] (wa)”.

Turning back to the step S602, if the variable “N” exceeds the value counted in the step S601, the operation goes to a step S607. That is, when the CPU 203 finishes the layering of all the nodes the required retrieval times of which are less than the target retrieval time (the nodes of the partial character string the required retrieval times of which do not exceed the target retrieval time), the CPU 203 goes to the step S607.

After the CPU 203 selects the node in the step S603, the CPU 203 reads the required retrieval time set to the selected node (S604). For example, the CPU 203 read the required retrieval time set to the one-gram node of [symbol] (a)” in the trie 501 shown in FIG. 5. Then, the CPU 203 executes the process of grouping the nodes as a family with relation to a parent node based on the required retrieval time read at the previous step (S605). Afterwards, the CPU 203 increments the variable “N” (S606) and goes to the step S607. The process of grouping the nodes as a family with relation to a parent node to be executed in the step S605 will be described with reference to FIG. 7.

At first, the CPU 203 determines if the required retrieval time set to the node selected in the step S603 of FIG. 6 is equal to or more than the target retrieval time (S700 shown in FIG. 7). For example, when the required retrieval time set to the one-gram node of [symbol] (a) in the trie 501 shown in FIG. 5 is “5.0”, the CPU 203 determines if this value of “5.0” is equal to or more than the target retrieval time. This determination is executed by the index retrieval time comparing program 218.

If the required retrieval time set to the node selected in the step S603 is equal to or more than the target retrieval time (Yes in the step S700 of FIG. 7), the CPU 203 increments the variable “M” (S701). As described above, the CPU 203 counts the number of the nodes of the longer required retrieval time (the nodes of the partial character strings of the longer required retrieval time). Further, the CPU 203 stores the nodes of the partial character strings of the longer required retrieval time in the predetermined area of the main storage unit 209. Those nodes are intended so that they may be grouped as a family with relation to a parent node. For example, when the required retrieval time set to the one-gram node of [symbol] (a)” shown in FIG. 5 is equal to or more than the target retrieval time, the information of the one-gram node [symbol] (a)” is stored as the information of the grouped nodes in the predetermined area of the main storage unit 209.

Afterwards, the CPU 203 puts the variable “P” to “0” and the variable “total” to “0” (S702) and then goes to the step S606. That is, the CPU 203 determines that the nodes of the longer required retrieval time (the nodes of the partial character strings of the longer required retrieval time) are not to be grouped as a family with relation to a parent node and shifts its operation to the adjacent node. For example, when the required retrieval time set to the one-gram node of [symbol] (a)” in the trie shown in FIG. 5 is equal to or more than the target retrieval time, the CPU 203 shifts its operation to another one-gram node (for example, the node of [symbol] (i)”).

On the other hand, when the required retrieval time set to the node selected in the step S603 (See FIG. 6) is less than the target retrieval time (No in the step S700), the CPU 203 adds the required retrieval time of the node selected in the step S603 to the variable “total” (S703). For example, the required retrieval time set to the one-gram node of [symbol] (a)” in the trie shown in FIG. 5 is “5.0” and the required retrieval time is less than the target retrieval time, the CPU 203 adds this required retrieval time “5.0” to the variable “total”. Further, the CPU 203 stores the nodes of the partial character strings of the shorter required retrieval time in the predetermined area of the main storage unit 209.

Then, the CPU 203 causes the index retrieval time comparing program 218 to start so that it is determined if the variable “total” to which the required retrieval time is added reaches the target retrieval time (S704). If the variable “total” with an addition of the required retrieval time is made equal to or more than the target retrieval time (Yes in S704), the CPU 203 determines if the value of the variable “P” exceeds 1 (S705). If the variable “P” exceeds 1 (Yes in S705), that is, if another node of the partial character string of the shorter required retrieval time is left in the adjacent nodes, the operation of the CPU 203 goes to the step S706. For example, when the CPU 203 adds the required retrieval time “1.0” set to the one-gram node of [symbol] (i)” to the variable “total”, if the added value becomes equal to or more than the target retrieval time and another node of the partial character string of the shorter required retrieval time (for example, the one-gram node of [symbol] (a)”) is left in the adjacent nodes, the CPU 203 goes to the step S706. On the other hand, when the variable “P” is equal to or less than 1 (No in S705), the CPU 203 goes to the step S606 of FIG. 6.

If the variable “total” to which the required retrieval time is added is still less than the target retrieval time (No in S704), the CPU 203 increments the value of the variable “P” (S709) and then goes to the step S605 of FIG. 6.

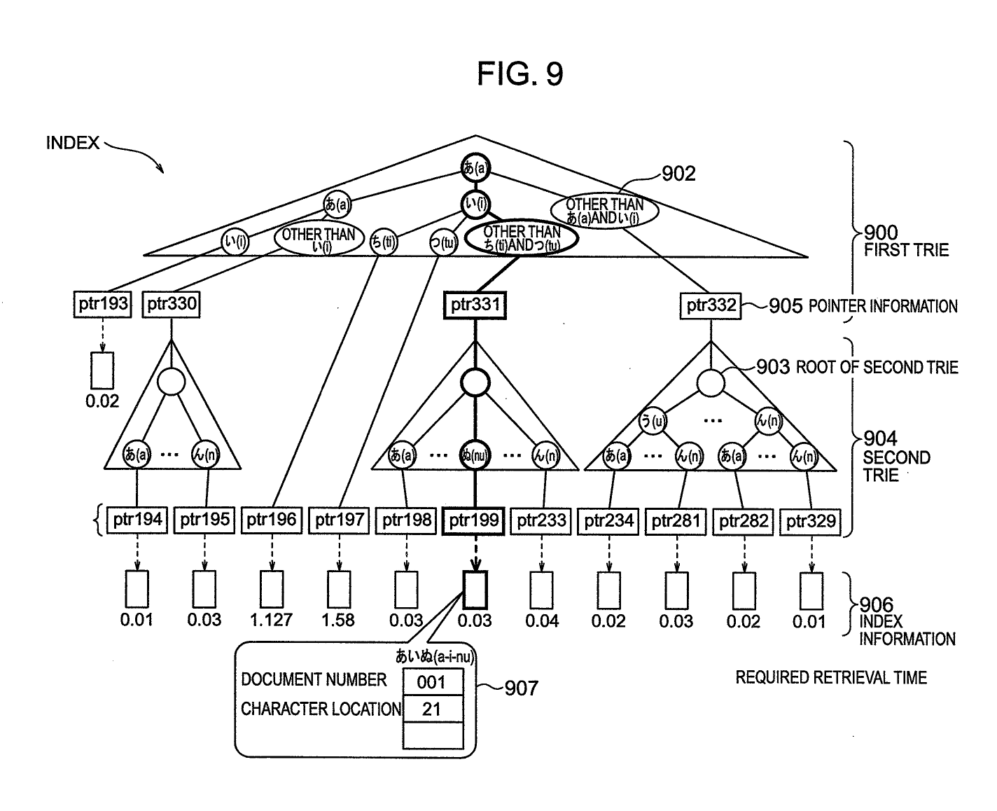

In the step S706, the CPU 203 starts the index layered node generating program 217. Then, the CPU 203 makes the nodes of the shorter required retrieval time grouped as a family with relation to a parent node and make the trie layered through the grouped nodes. The process of grouping the nodes as a family with relation to a parent node and layering the trie to be executed by the index layered node generating program 217 will be described later in detail with reference to FIG. 8. For example, in the foregoing example, the program 217 is executed to make the one-gram node of [symbol] (i)” and the one-gram node of “ [symbol] (a)” in the trie 501 grouped as a family with relation to a parent node and to layer the trie based on the grouped nodes.

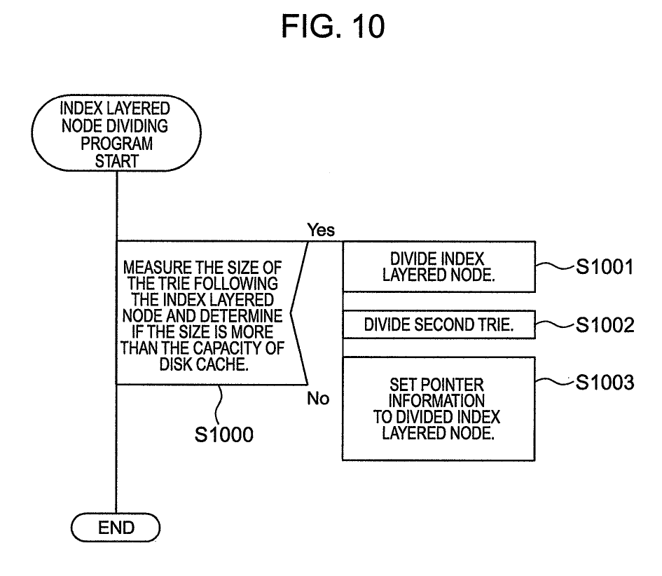

Next, the CPU 203 starts the index layered node dividing program 220 (S707). Then, the CPU 203 divides the grouped nodes and the layered trie. The division of the grouped nodes and the layered trie will be described later in detail with reference to FIG. 9.

Then, the CPU 203 puts the value of the variable “P” to “0” and the value of the variable “total” to “0” (S708). Then, the CPU 203 shifts its operation to the step S606 of FIG. 6.

Turning back to FIG. 6, the description about the process of S606 or later is continued. The CPU 203 increments the value of the variable “N” (S606) and goes back to the step S602. Then, the CPU 203 continues the process of S603 to S606 until the value of the variable “N” reaches the number counted in the step S601 (corresponding to the number of the adjacent nodes). That is, the process of S603 to S606 is executed with respect to all the adjacent nodes. Then, when the value of the variable “IN” exceeds the number counted in the step S601 (the number of the adjacent nodes), the CPU 203 goes to the step S607. That is, when the process of all the adjacent nodes of the shorter retrieval time (the nodes of the partial character strings of the shorter required retrieval time) is finished, the CPU 203 starts the process of the nodes of the longer required retrieval time (the nodes of the partial character strings of the longer required retrieval time).

At first, the CPU 203 determines if the variable “L” is equal to or less than the variable “M” (the number of the nodes of the partial character strings of the longer required retrieval time+1) (S607). Herein, when the variable “L” is equal to or less than the variable “M”, the CPU 203 selects one node that is not processed yet from the nodes of the partial character strings of the longer required retrieval time (S608). For example, when the one-gram node of [symbol] (i) in the trie 501 shown in FIG. 5 corresponds to the node of the partial character string of the longer required retrieval time, the CPU 203 selects the one-gram node of [symbol] (i)”.

Then, the CPU 203 increments the value of the variable “L” (S609) and searches the nodes following the node selected in the step S608 (S610). For example, the CPU 203 searches the two-gram node following the one-gram node of [symbol] (u)” in the tire 501 shown in FIG. 5. Herein, it is determined if the following node exists (S611). If yes, the CPU 203 layers this node (S612). That is, the CPU 203 executes the process of S600 or later with respect to the following gram node in the trie. For example, if the two-gram node exists after the one-gram node of [symbol] (i)”, that is, if a child node of the one-gram node of [symbol] (i)”, the process of S600 or later is executed with respect to the one-gram node. Then, after the child node of the one-gram node of [symbol] (i)” is finished, the CPU shifts its operation to the process of another one-gram node (like the one-gram node of [symbol] (u)”).

On the other hand, if no following node exists, the CPU 203 goes back to the step S608, in which the CPU 203 starts the process of the node that is not processed yet. That is, in the trie 501 shown in FIG. 5, if no child node of the one-gram node of [symbol] (i)” exists, the CPU 203 starts to process another one-gram twin node (for example, the one-gram node of [symbol] (u)”). Then, the CPU 203 continues this process until the variable “L” becomes equal to the variable “M”. That is, the CPU 203 continues the process until the process of all the nodes of the partial character strings of the longer required retrieval time is completed. In particular, in the foregoing example, the foregoing process is executed with respect to all the nodes of the partial character strings of the longer required retrieval time in the one-gram nodes.

### (Index Layered Node Generating Program)

In turn, the index layered node generating program 217 will be described in detail through the use of the PAD shown in FIG. 8 with reference to FIGS. 2, 5 and 9. FIG. 8 shows the procedure of the index layered node generating program. FIG. 9 shows the trie generated on the trie shown in FIG. 5.

The CPU 203 reads the nodes that are to be grouped as a family with relation to a parent node (that is, the partial character strings of the shorter required retrieval time) from the main storage unit 209 and generates the index layered node in which those nodes are grouped as a family with relation to a parent node (S800).

For example, when all the nodes other than the two-gram nodes of [symbol] (a)” and [symbol] (i)” (that is, the two-gram nodes of [symbol] (u)” to [symbol] (n)”) in the trie 501 shown in FIG. 5 are stored as the nodes that are to be grouped as a family with relation to a parent node in the main storage units 209, the CPU 203 reads the two-gram nodes of [symbol] (u)” to [symbol] (n)” and generates the index layered node by collecting the read nodes. (Refer to the reference number 902.) The index layered node is labeled by “other than [symbol] (a) and [symbol] (i)” as shown by the reference number 902 of FIG. 9.

Further, the CPU 203 copies the nodes to be grouped as a family with relation to a parent node and the nodes connected therewith into a working area 225. Then, the CPU 203 deletes the nodes to be grouped and the nodes connected therewith from the trie and then puts the index layered node in the place where the nodes that are to be grouped are located. That is, the nodes that are grouped and the nodes connected therewith are replaced with the index layered node. Next, the CPU 203 deletes the nodes as described above and stores in the upper partial character string storage area 224 the trie with the index layered node located therein as the first trie (S801).

For example, in the trie 501 shown in FIG. 5, the CPU 203 copies all the two-gram nodes of [symbol] (u)” to [symbol] (n)” and the nodes connected therewith to the working area 225. Then, the CPU 203 deletes those nodes from the trie 501 and puts the index layered node 902 in place of the two-gram nodes of [symbol] (u)” to [symbol] (n)”. The CPU 203 deletes the nodes to be grouped as described above and stores in the upper partial character string storage area 224 shown in FIG. 2 the trie in which the index layered node is located as the first trie. (Refer to the reference number 900 of FIG. 9.)

The foregoing operation of the CPU 203 makes it possible to keep the number of nodes and the size of the generated first trie small. Hence, the document registering and retrieving system 200 may be provided with the trie even if the capacity of the main storage unit 209 of the system is small.

Further, the CPU 203 layers the nodes connected with the index information items 207 of the shorter required retrieval time but does not layer the nodes connected with the index information items 207 of the longer required retrieval time. Hence, when retrieving the index information item 207 of the shorter required retrieval time, the retrieving operation of the CPU 203 passes through the second trie stored in the secondary storage unit 205, while when retrieving the index information item 207 of the longer required retrieval time, the retrieving operation comes immediately from the first trie stored in the main storage unit 209 to the index information items 207 without through the second trie. This operation makes it possible to improve the retrieving efficiency of the index information items 207 throughout the whole system.

Next, the CPU 203 generates the second trie connected with the index layered node generated in the step S800 and then stores the second trie in the lower partial character string storage area 208 shown in FIG. 2 (S802). That is, the CPU 203 reads the nodes to be grouped, stored in the working area 225, and the nodes connected with the former nodes. Then, the CPU 203 puts a parent node (See a root 903 of the second trie shown in FIG. 9.) in the read nodes to be grouped. The CPU 203 stores in the storage area 208 shown in FIG. 2 the trie with the root 903 of the second trie as a vertex as the second trie 904 connected with the index layered node.

After the storage area of the second trie is defined as described above, the CPU 203 sets the pointer information items that designate the storage areas of the second trie to the index layered node functioned as the connectors of the second trie.

For example, in the step S802, the CPU 203 reads from the working area 225 the two-gram nodes of [symbol] (u)” to [symbol] (n)” of the trie shown in FIG. 5 and the nodes connected with those nodes. Then, the CPU 203 puts a parent node (See the roots 903 of the second trie shown in FIG. 9.) to the read nodes. Next, the CPU 203 stores in the storage area 208 of the secondary storage unit 205 the trie with the root 903 of the second trie as a vertex as the second trie 904 connected with the index layered node 902. Then, the CPU 203 sets the pointer information item 905 (“ptr332”) that designates the storage area of the second trie 904 to the two-gram index layered node 902 “other than [symbol] (a)” and [symbol] (i)“ ” of the first trie 900.

When the CPU 203 retrieves the index information item 906, the foregoing operation makes it possible to jump from the index layered node of the first trie to the second trie (or the root of the second trie) following the index layered node and then reach the index information item 906.

After the foregoing process, the CPU 203 causes the index layered node dividing program 220 to divide the index layered node according to the size of the second trie.

### (Index Layered Node Dividing Program)

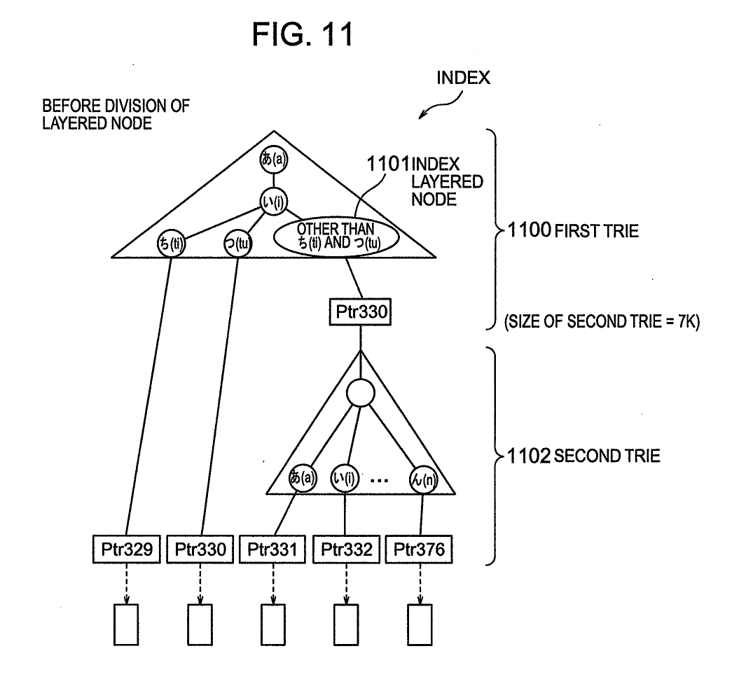

In turn, the index layered node dividing program 220 will be described in detail by using the PAD shown in FIG. 10 with reference to FIG. 2. FIG. 10 shows the procedure of the index layered node dividing program shown in FIG. 2.

At first, the CPU 203 of FIG. 2 operates to measure the size of the second trie following the index layered node and determine if the size is more than the capacity of the disk cache of the secondary storage unit 205 (S1000).

Herein, if the size of the second trie is equal to or less than the capacity of the disk cache of the secondary storage unit 205 (No in the step S1000), the CPU 203 does not divide the index layered node, while if the size of the second trie is more than the capacity of the disk cache (Yes in the step S1000), the CPU 203 reads the index layered node, stored in the upper partial character string storage area 224, onto the working area 225 and divides the index layered node (S1001). In the step S1001, the divided index layered nodes are put back to the upper partial character string storage area 224 shown in FIG. 2. Of course, the index layered node is divided so that the size of the second trie following the divided index layered nodes is equal to or less than the capacity of the disk cache. This division allows the CPU 203 to retrieve the second trie stored in the secondary storage unit 205 at fast speed.

In the step S1001, the divisional number may be as small as possible in the range that the size of the second trie following the divided index layered nodes is equal to or less than the capacity of the disk cache. That is, the division in the step S1001 is preferable to make the size of the divided second trie equal to or less than the capacity of the disk cache and the number of the divided second tries as small as possible. This is because the division causes the number of the divided second tries to be increased and accordingly the number of the index layered nodes in the first trie to be increased, thereby making the size of the first trie larger.

Then, the CPU 203 reads the second trie stored in the storage area 208 onto the working area 225 and divides the second trie according to the division of the index layered node in the step S1001 (S1002). Next, the CPU 203 puts the root of the second trie in each of the divided second tries and then stores the result in the storage area 208.

After the storage area of the divided second tries is defined, the CPU 203 sets the pointer information item for the storage area of the second trie to the index layered node divided in the step S1001 (S1003).

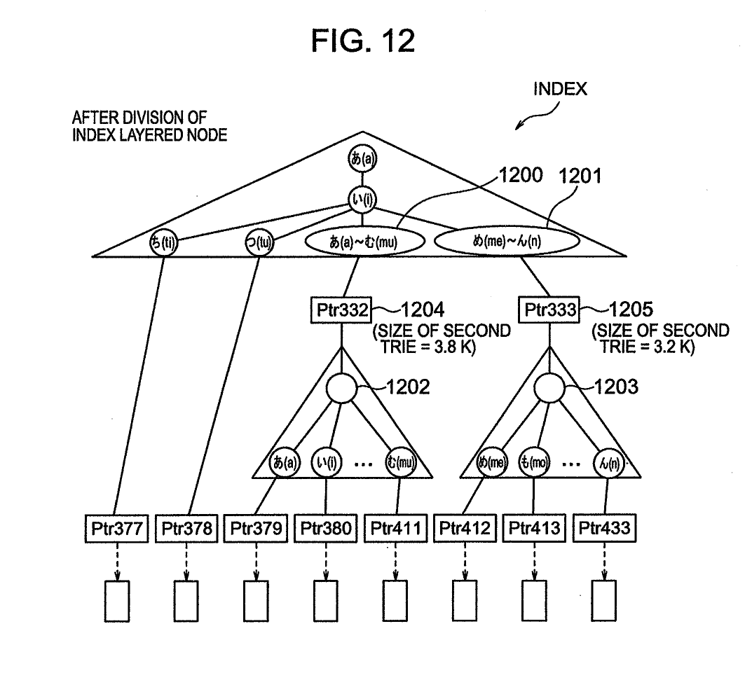

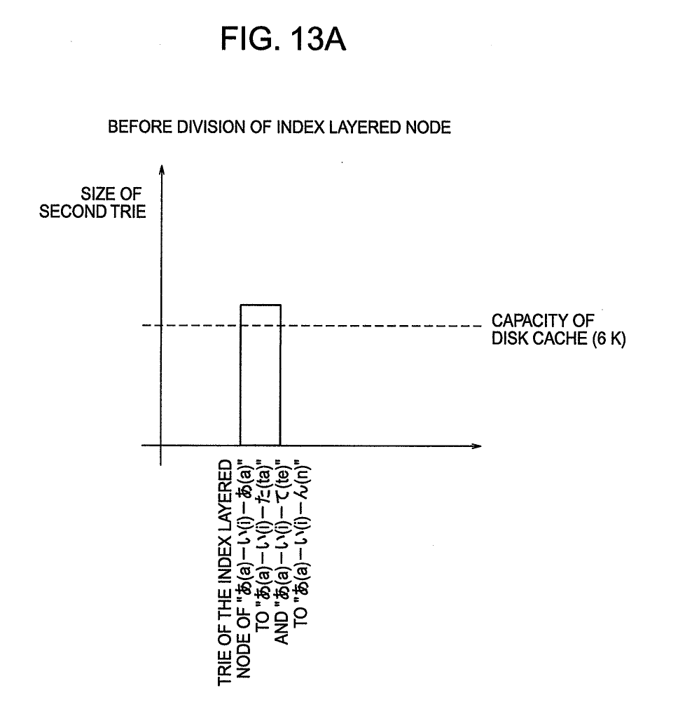

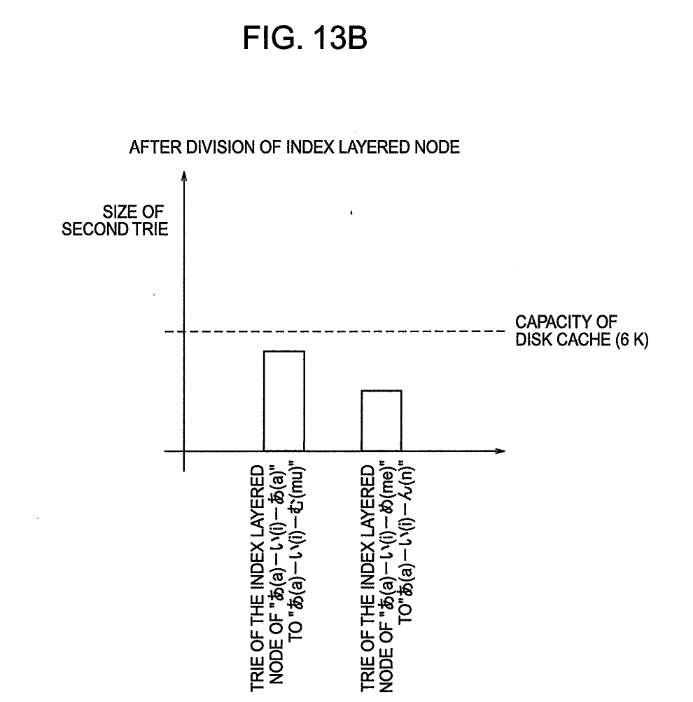

Herein, the dividing process of the index layered node will be described in detail with reference to FIGS. 11 to 13B. FIGS. 11 and 12 conceptually show the process of dividing the index layered node according to this embodiment. FIGS. 13A and 13B are views cited for explaining FIGS. 11 and 12. In the following description, it is assumed that the storage capacity of the disk cache of the secondary storage unit 205 is 6 k.

For example, in the first trie 1100 shown in FIG. 11, the size of the second trie 1102 following the index layered node 1101 “other than [symbol] (ti)” and [symbol] (tu)”)” is 7 k. Hence, the size of the second trie 1102 exceeds the capacity of the disk cache to be stored in the secondary storage unit 205.

Hence, the CPU 203 divides the second trie 1102 so that the size of the second trie 1102 is equal to or less than 6 k and accordingly divides the index layered node 1101.

For example, the CPU 203 divides the three-gram index layered node 1101 “other than [symbol] (ti)” and [symbol] (tu)“ ” into two index layered nodes that are the index layered node 1200 [symbol] (a) to [symbol] (mu)”) and the index layered node 1201 [symbol] (me) to [symbol] (n)”) as shown in FIG. 12. The index layered node 1101 is divided in a manner that the second trie following the index layered node 1200 [symbol] (a) to [symbol] (mu)”) has a size of 3.8 k and the second trie following the index layered node 1201 [symbol] (me) to [symbol] (n)” has a size of 3.2 k. That is, each size of the divided second tries is equal to or less than the capacity of the disk cache to be stored. Then, the CPU 203 puts the roots 1201 and 1203 in the divided second tries respectively. Further, the CPU 203 sets the pointer information items 1204 and 1205 that designate the storage areas of the divided second tries to the index layered nodes 1200 and 1201 respectively.

In particular, as shown in the graph of FIGS. 13A and 13B, before dividing the index layered node 1101 shown in FIG. 11, the size of the second trie of the index layered node of [symbol] (a)- [symbol] (i)- [symbol] (a)” to [symbol] (a)- [symbol] (i)- [symbol] (ta)” and [symbol] (a)- [symbol] (i)- [symbol] (te)” to [symbol] (a)- [symbol] (i)- [symbol] (n)” is more than the capacity (6 k) of the disk cache. On the other hand, by dividing the index layered node 1101 into the index layered node 1200 of [symbol] (a)- [symbol] (i)- [symbol] (a)” to [symbol] (a)- [symbol] (i)- [symbol] (mu)” and the index layered node 1201 of [symbol] (a)- [symbol] (i)- [symbol] (me)” to [symbol] (a)- [symbol] (i)- [symbol] (n)”, the size of the corresponding second trie with the divided index layered node 1200 or 1201 is made equal to or less than the capacity (6 k) of the disk cache.

The foregoing division of the index layered node executed by the CPU 203 allows the size of the second trie to be equal to or less than the capacity of the disk cache located in the secondary storage unit 205. Hence, the CPU 203 enables to retrieve the index information items 207 through the disk cache at fast speed.

### (Retrieving Process)

In turn, the description will be oriented to the procedures of the CPU 203 which retrieves the index information through the index generated by the foregoing process. The retrieval of the index information item 207 concerning the retrieval term inputted by a user is executed when the CPU 203 causes the system control program 212 to start the retrieval control program 211. The retrieval control program 211 is started by the execution of the index retrieving program 221.

### (Index Retrieving Program)

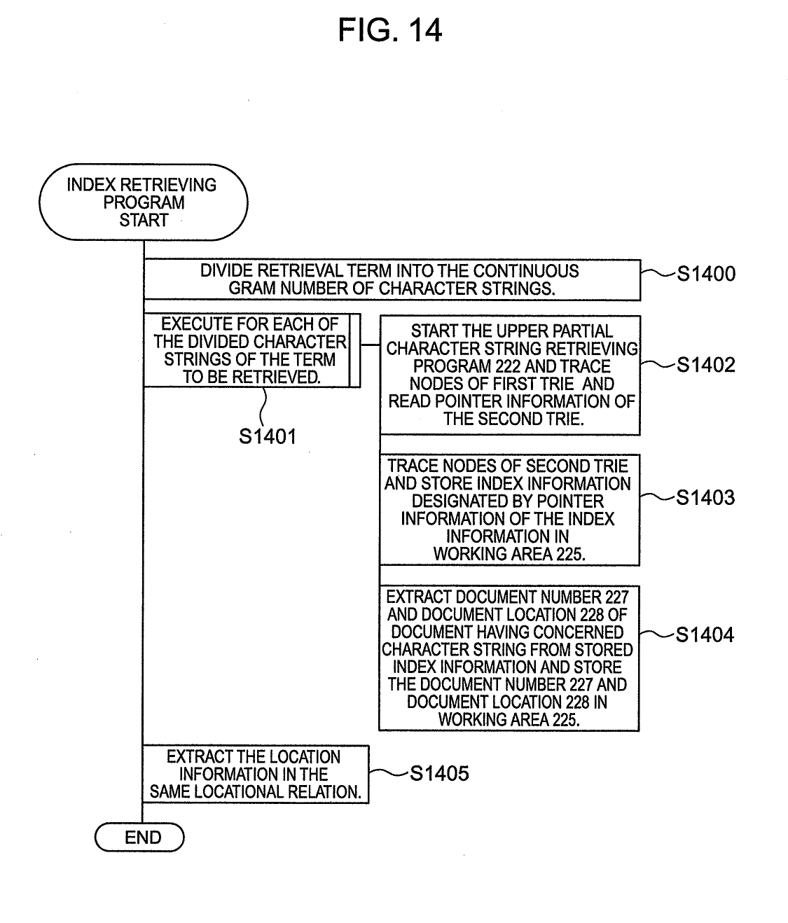

The index retrieving program 221 will be described in detail by using the PAD shown in FIG. 14. FIG. 14 shows the procedure of the index retrieving program shown in FIG. 2. Herein, the description will be oriented to the case in which the CPU 203 traces the nodes of the first trie 900 and the second trie 904 shown in FIG. 9 for the purpose of retrieving the index information 207.

At first, the CPU 203 divides the term to be inputted for retrieval into the continuous gram number of character strings (S1400). Herein, the character number of the divided character string is equal to or less than the gram number (predetermined length) of the index. For example, if the term to be retrieved is [symbol] [symbol] (a-i-nu-jin)”, since the index shown in FIG. 9 has a three gram length, the CPU 203 divides the term into the character strings each of which has three or less characters, that is, [symbol] (a-i-nu)” and [symbol] (jin)_”.

Next, the CPU 203 continuously executes the following process of S1402 to S1404 for each of the divided character strings of the term to be retrieved (S1401). For example, if the term of [symbol] (a-i-nu-jin)” is divided into two character strings of [symbol] (a-i-nu) and [symbol] (jin)_”, the process of S1402 to S1404 is executed twice.

Then, the CPU 203 starts the upper partial character string retrieving program 222. Afterwards, the CPU 203 traces the first trie about the divided character string and reads the pointer information item of the second trie set to the end node of the first trie (S1402). By this operation, the CPU 203 retrieves the character string (upper partial character string) included in the first trie from the divided character string and reads the pointer information item of the lower partial character string (character string included in the second trie) following the upper partial character string.

For example, the CPU 203 traces the one-gram node of [symbol] (a)”, the two-gram node of [symbol] (i)”, and the three-gram node of “other than [symbol] (ti) and [symbol] (tu)” on the first trie 900 shown in FIG. 9. Then, the CPU 203 reads the pointer information item (“ptr331”) of the second trie set to the end node, that is, three-gram node of “other than [symbol] (ti) and [symbol] (tu)” (index layered node).

Next, the CPU 203 starts the lower partial character string retrieving program 223. In succession, based on the pointer information item of the second trie read in the step S1402, the CPU 203 accesses the second trie. Then, the CPU 203 traces the nodes of the second trie and reads onto the working area 225 the index information item 207 designated by the pointer information item (pointer information item of the index information) set to the end node of the second trie (S1403).

For example, based on the pointer information item “ptr331” of the second trie set to the three-gram node of “other than [symbol] (ti) and [symbol] (tu)” of the first trie 900 shown in FIG. 9, the CPU 203 accesses the second trie 904 following the node of “other than [symbol] (ti) and [symbol] (tu)”. Then, the CPU 203 reads onto the working area 225 the index information item 207 designated by the pointer information “ptr199” set to the node of [symbol] (nu)” of the second trie. That is, the CPU 203 reads the index information item 207 with [symbol] (a-i-nu)” as a retrieval item onto the working area 225.

Next, the CPU 203 extracts the document number 227 and the character location (location information) 228 including the concerned character string from the read index information item 207 and then stores them onto the working area 225 (S1404).

For example, the CPU 203 extracts the document number “001” and the character location “21” including [symbol] (a-i-nu)” stored in the index information item of [symbol] (a-i-nu)” shown by the reference number 907 of FIG. 9 and then stores them onto the working area 225. That is, the CPU 203 extracts the information in which the character string of [symbol] (a-i-nu)” is at the character location “21” of the document of the document number “001”.

The CPU 203 executes the foregoing process for each of the divided character strings of the term to be retrieved. Concretely, after the process of the character string [symbol] (a-i-nu)” is finished, the CPU 203 executes the same process for the character string of [symbol] (jin)_”. That is, the CPU 203 extracts the document number and the character location (location information) of the document including the character string of [symbol] (jin)_” and stores them onto the working area 225.

Upon completion of extracting the location information of all the character strings, the CPU 203 extracts the location information items in the same locational relation from the location information of each character string stored in the working area 225 (S1405). That is, the CPU 203 retrieves the location information of the character strings listed in the same locational relation as the range of the retrieval terms and outputs the location information.

For example, the CPU 203 extracts the document number “001” and the character location “21” for the location information of [symbol] (a-i-nu)”. Further, though not shown, the CPU extracts the document number “001” and the character location “24” for the location information of [symbol] (jin)_”. In this case, both of the character strings have the same document number, and the character string [symbol] (jin)_” (the head character [symbol] (ji)” is the 24th) is located to follow the character string [symbol] (a-i-nu)” (the head character [symbol] (a)” is the 21st). That is, both of the character strings are listed in the same locational relation as the retrieval term. Hence, the CPU 204 enables to retrieve the information in which the character string of [symbol] (a-i-nu-jin)” is located at the character location “21” or later in the document of the document number “001”.

The foregoing operation allows the CPU 203 to obtain the location information of the retrieval term in the document.

### Second Embodiment

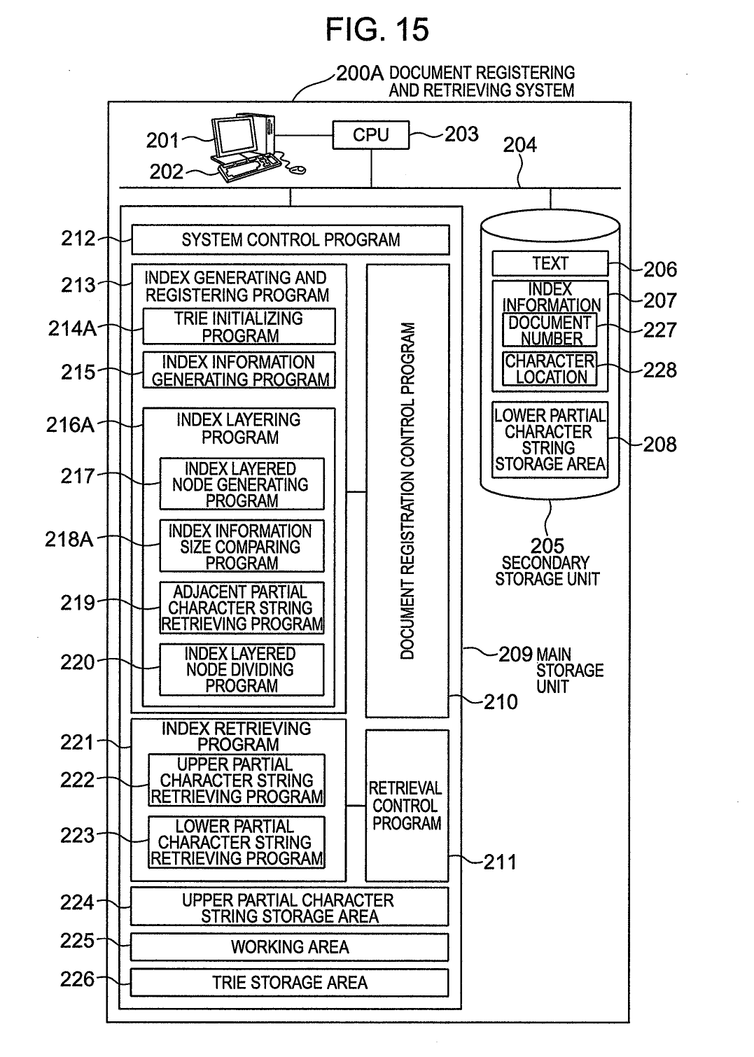

In the document registering and retrieving system according to the second embodiment, it is determined if a certain node is to be grouped on the size of the index information 207 (the total size of the index information) instead of the required retrieval time of the index information 207. FIG. 15 shows an exemplary arrangement of the document registering and retrieving system according to the second embodiment of the present invention.

As shown in FIG. 15, the document registering and retrieving system 200A according to the second embodiment provides a trie initializing program 214A instead of the trie initializing program 214 show in FIG. 2 and an index layering program 216A instead of the index layering program 216 shown in FIG. 2. In this index layering program 216, an index information size comparing program 218A instead of the index retrieval time comparing program 218 as shown in FIG. 15. The same components of the second embodiment as those of the first embodiment have the same reference numbers and the description thereabout is left out. Further, the run of the index information size comparing program 218A by the CPU 203 results in realizing the function of the index information size comparing unit claimed in a claim.

The trie initializing program 214A is executed to add to each node of the trie the information of the size of the index information 207 (the total size of the index information) following the node.

Further, the index layering program 216A causes the index information size comparing program to compare the size of the index information (the total size of the index information) of one node with that of another node and determined if the concerned node is to be layered in the index based on the compared result.

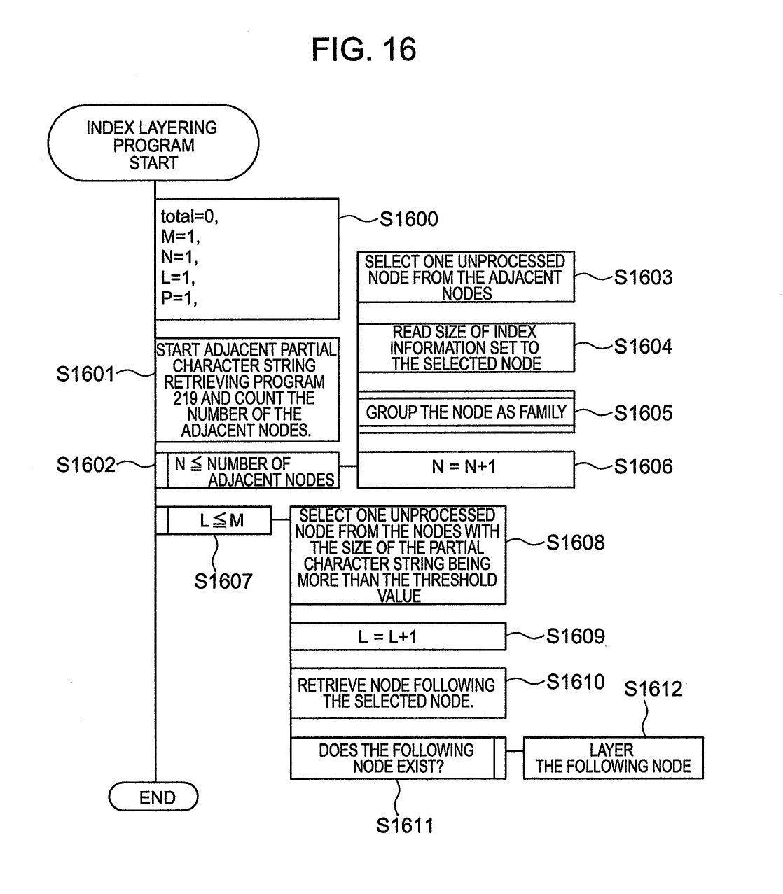

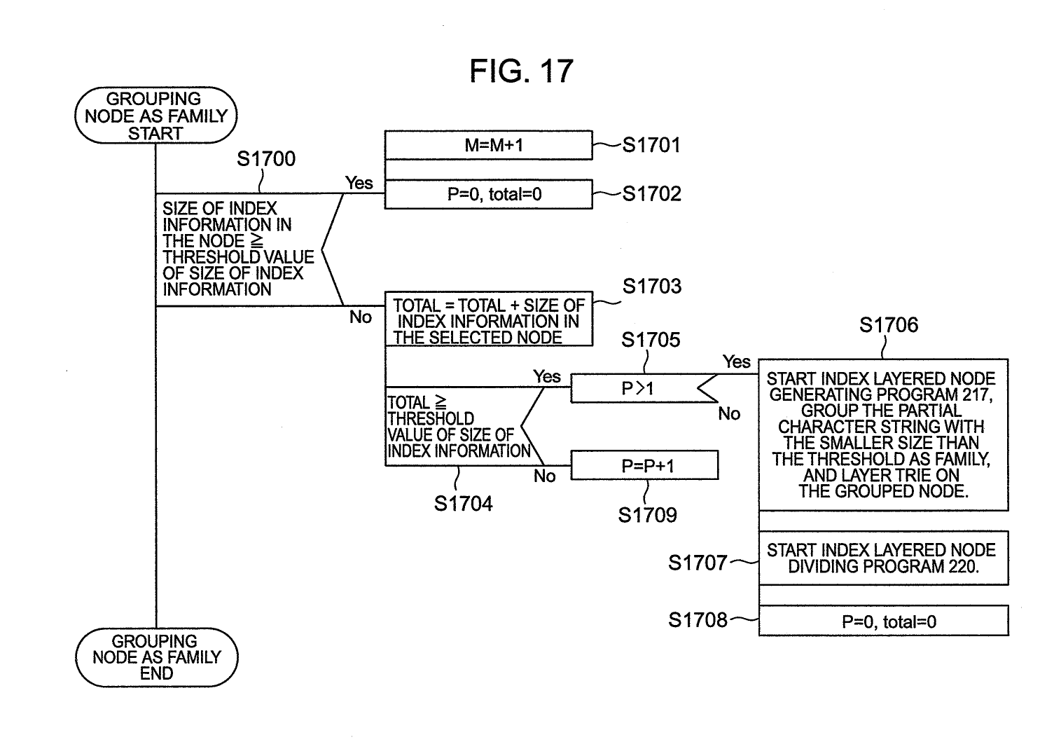

The procedure of the index layering program 216A will be described with reference to FIGS. 16 and 17. FIGS. 16 and 17 show the procedure of the index layering program shown in FIG. 15. The process of the steps S1600 to S1603 shown in FIG. 16 is likewise to the process of the steps S600 to S603 shown in FIG. 6. Hence, the description thereabout is left out and the description of the program is started from the step S1604. The variable “total” in this flow of process is used for calculating the total value of the sizes of the index information items set to the nodes.

The CPU 203 selects a node in the step S1603 and then reads the size of the index information item set to the selected node (S1604). For example, the CPU 203 reads the size of the index information item 207 set to the one-gram node of [symbol] (a)” of the trie 501 shown in FIG. 5. Then, based on the read size of the index information item 207, the node is grouped by the CPU 203 (S1605). The process of the step S1606 is likewise to that of the step S606 shown in FIG. 6 and thus the description thereabout is left out. The process of grouping the node as a family in the step S1605 will be described with reference to FIG. 17.

At first, the CPU 203 determines if the size of the index information item 207 set to the node selected in the step S1603 is equal to or more than a predetermined threshold value (that is, the threshold value of the size of the index information item) (S1700 shown in FIG. 17). This determination is executed by the foregoing index information size comparing program 218A.

If the size of the index information item set to the node selected in the step S1603 is equal to or more than the predetermined threshold value (the predetermined threshold value of the index information) (Yes in the step S1700), the process from S1701 to S1702 is executed. This process is likewise to the process of S701 to S702 shown in FIG. 7 and thus the description thereabout is left out.

On the other hand, if in the step S1700 the size of the index information item set to the node selected in the step S1603 is less than the threshold value (No in the step S1700), the CPU 203 adds the size of the index information item set to the node selected in the step S1603 to the variable “total” (S1703).

Then, the CPU 203 causes the index information size comparing program 218A to determine if the variable “total” to which the size of the index information item is added is equal to or more than the predetermined threshold value (S1704). If the variable “total” to which the size of the index information size is added is equal to or more than the foregoing predetermined threshold value (the predetermined threshold value of the index information) (Yes in the step S1704), it is determined if the value of the variable “P” is 1 or more (S1705). If the variable “P” exceeds 1 (Yes in the step S1705), that is, if another node with the size of the partial character string being less than the threshold value (referred to as the node of the smaller character string) is adjacent to the concerned node, the process goes to the step S1706. On the other hand, if the variable “P” is 1 or less (No in the step S1705), the CPU 203 causes the process to go to the step S1606 shown in FIG. 16.

If the variable “total” to which the size of the index information item is added is less than the foregoing predetermined threshold value (the predetermined threshold value of the index in formation) (No in the step S1704), the CPU 203 increments the variable “p” (S1709) and then causes the process to go to the step S1606 shown in FIG. 16.

In the step S1706, the CPU 203 causes the index layered node generating program 217 to start. Then, the CPU 203 groups node of the smaller character string as a family and the trie is layered with relation to this node (S1706). The subsequent process of S1707 to S1708 is likewise to the process of S707 to S708 shown in FIG. 7 and thus the description thereabout is left out.

The process of S1607 shown in FIG. 16 is likewise to that of S607 shown in FIG. 6 and thus the description thereabout is left out. Then, the description is started from the step S1608. In the step S1607, if the variable “L” is equal to or less than the variable “M”, the CPU 203 selects one node that is not processed from the nodes with the size of the partial character string being or more than the threshold value (referred to as the nodes of the larger character string) stored in the main storage unit 209 (S1608). Then, with respect to all the nodes of the larger character string, the process of S1609 to S1612 is executed by the CPU 203. The process of S1609 to S1612 is likewise to the process of S609 to S612 shown in FIG. 6 and thus the description thereabout is left out.

As described above, the use of the size (the total size) of the index information item 207 makes it possible for the CPU 203 to generate the retrieval-efficient trie.

### Other Embodiments

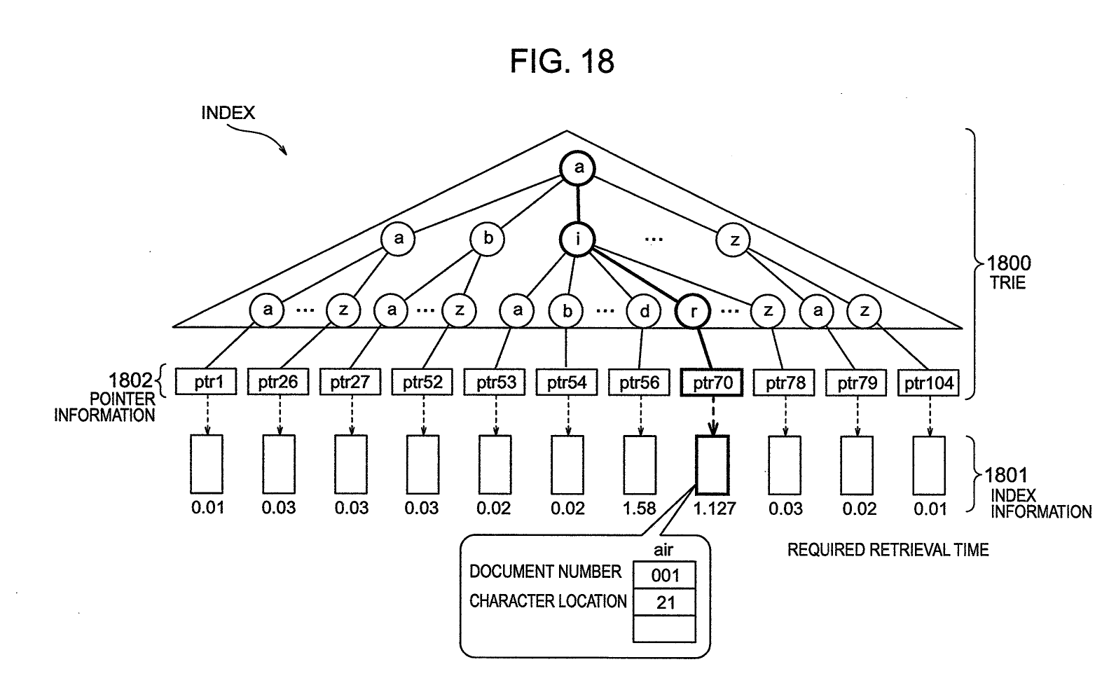

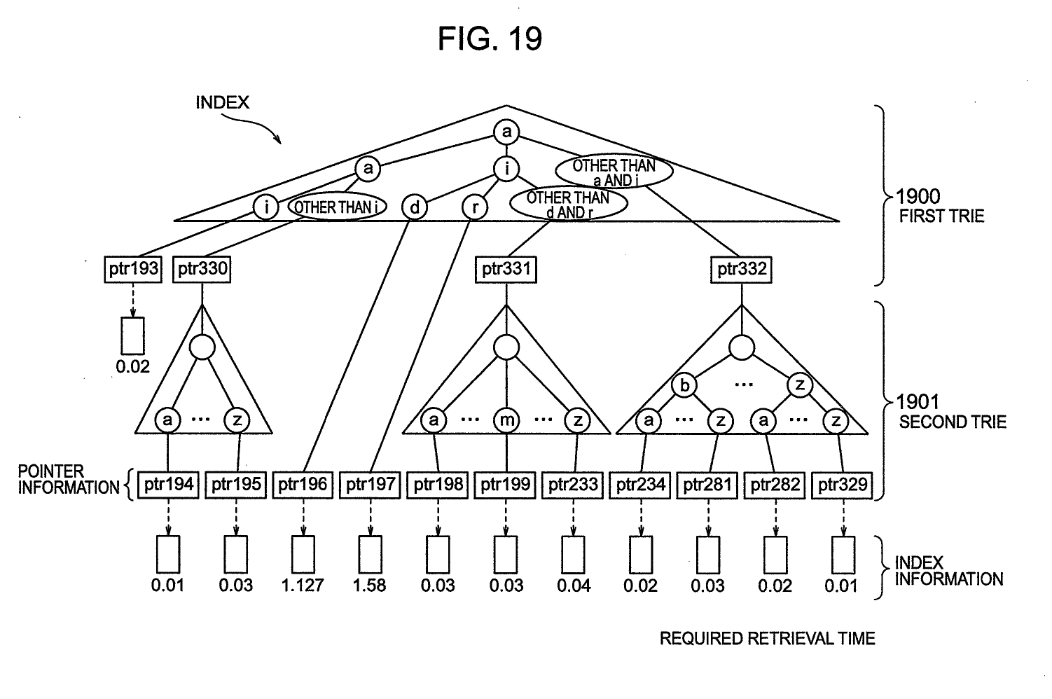

The foregoing embodiments have been described with reference to the case that the nodes in the trie use the Japanese characters of “hiragana”. In place of the characters “hiragana”, the other Japanese characters of “katakana” or “Kanji” may be used therefore. Further, if the text 206 includes the other language characters than the Japanese characters, these characters may be used for the nodes in the trie. FIG. 18 shows the index of this embodiment. FIG. 19 shows the layered index of FIG. 18.

For example, if the text 206 is written in English, the trie generated by the trie initializing programs 214 and 214A executed by the document registering and retrieving systems 200 and 200A includes the nodes each of which corresponds to one alphabetic character as shown in FIG. 18. For example, as shown in FIG. 18, the retrieval operation is executed to trace the node of “a”, the node of “i” and the node of “r”. The pointer information item 1802 set to the end node of “r” designates the index information item 1801 of the character string of “air”. Further, the document registering and retrieving systems 200 and 200A layer the alphabetic trie 1800 as shown in FIG. 18, so that if the first trie 1900 and the second trie 1901 are generated as shown in FIG. 19, each alphabetic character corresponds to each of the nodes of these tries.

In the foregoing embodiments, the index information 207 has been the index information of the character string include in the text 206. Instead of the character string, the picture data or the moving image data may be used as the index information.

Further, the document registering and registering system 200 or 200A may be arranged to exclude the index layered node dividing program 220. In particular, the system 200 or 200A may be arranged not to divide the index layered node after generating the index layered node.

Moreover, the system 200 or 200A are arranged to have both the index generating and registering program 213 and the index retrieving program 221. Those programs 213 and 221 may be separated from each other. In particular, apart from the computer that causes the index generating and registering program 213 to generate the index, there may be provided another computer that causes the index retrieving program 221 to retrieve the index.

In addition, the secondary storage unit 205 of the system 200 or 200A may be installed outside.

In the foregoing embodiment, one character code may be matched to one gram. For example, for a 2-byte character code, two bytes (16 bits) may be matched to one gram, while for a 1-byte character code, one byte (8 bits) may be matched to one gram. Further, one gram may match to any bit length without being limited by the character code. In this arrangement, for example, in order to register and retrieve the symbol string, the trie may be generated so that the symbol code of four bits or two bits may be set as one gram.

In the foregoing embodiment, the system 200 or 200A is arranged to store the trie connected down with the grouped nodes in the lower partial character string storage area 208 in the trie form. Without being limited to the form, for example, in the secondary storage unit 205, the trie may be stored in the B tree form so that the CPU 203 may more easily access the data. Further, in order to reduce the disk capacity, the reduced trie may be stored in the secondary storage unit 20.

The programs included in the foregoing embodiments may be supplied in the computer-readable recording medium (like a CD-ROM) or through a network (like the Internet).

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

It should be further understood by those skilled in the art that although the foregoing description has been made on embodiments of the invention, the invention is not limited thereto and various changes and modifications may be made without departing from the spirit of the invention and the scope of the appended claims.

1. A method of generating a trie in which symbol strings of index items of index information are arranged in a tree structure of symbol nodes, comprising the steps of: causing a symbol string retrieving device provided with a main storage unit and a secondary storage unit to generate the trie;
causing the device to store the generated trie in the main storage unit;
causing the device to calculate a total of required retrieval times of index information items connected forward with the nodes composing the generated trie by referring to the required retrieval time of the index information item and to store the calculated required retrieval time of each node in the main storage unit;
causing the device to determine if the required retrieval time of each of the nodes composing the trie is equal to or less than a predetermined threshold value;
causing the device to generate an index layered node by selecting the nodes with the same parent node from the nodes with the required retrieval time being equal to or less than the predetermined threshold value and grouping the nodes as a family with relation to the same parent node;
causing the device to generate a first trie by replacing the nodes to be grouped as a family with relation to the same parent node and the nodes connected forward with the former nodes with the generated index layered node;
causing the device to store the generated first trie in a predetermined area of the main storage unit;
causing a second trie having the nodes to be grouped as a family with relation to the same parent node and the nodes connected forward with the former nodes in a predetermined area of the secondary storage unit; and
causing the device to set a pointer information item that designates the storage area of the second trie to the index layered node located in the first trie.

2. The method of generating the trie as claimed in claim 1, wherein the symbol string retrieving device operates to calculate a total of sizes of index information items connected forward with the nodes composing the trie by referring to a size of the index information stored in the secondary storage unit and to store the size of the calculated index information item of each node in the main storage unit,
determine if the size of the index information item of each of the nodes composing the trie is equal to or less than the predetermined threshold, and
generate the index layered node by selecting the nodes with the same parent node from the nodes with the size being equal to or less than the predetermined threshold value and grouping the node as a family with relation to the same parent node.

3. The method of generating the trie as claimed in claim 1, wherein if the size of the generated second trie is more than a capacity of a disk cache provided in the secondary storage unit, the symbol string retrieving device operates to divide the second trie so that the size of the second trie becomes equal to or less than the capacity of the disk cache,
divide the index layered node connected with the divided second trie, and
set the pointer information item that designates a storage area of the divided second trie to the divided index layered node.

4. The method of generating the trie as claimed in claim 3, wherein the second trie is divided so that the size of the second trie becomes equal to or less than the capacity of the disk cache and the divisional number of the second trie becomes the smallest number.

5. A method of retrieving the index information item through the use of the first and the second tries generated by the method of generating the trie as claimed in claim 1, comprising the steps of:
causing a symbol string retrieving device for retrieving a symbol string to accept an input of a retrieval term that is a symbol string to be retrieved;
causing the device to divide the retrieval term being inputted into a symbol string the length of which is equal to or less than a predetermined length;
causing the device to trace the first trie stored in the main storage unit about each divided symbol string and to read a pointer information item set to each end node of the first trie;
causing the device to access the second trie stored in the secondary storage unit on the basis of the read pointer information item;
causing the device to trace the nodes of the accessed second trie and read the pointer information item set to each end node of the second trie;
causing the device to read the location information item having a document including each divided symbol string and a symbol location of the symbol string in the document from the read index information item;
causing the device to retrieve the location information in which the divided symbol strings are in the same locational relation with the range of the terms to be retrieved; and
causing the device to output the retrieved location information.

6. A trie generating program for causing a computer that corresponds to a symbol string retrieving device to execute the process of generating the trie in which symbol strings of index items of index information are arranged in a tree structure of symbol nodes, comprising:
generating the trie, store the generated trie in a main storage unit located in the computer, calculate a total of required retrieval times of index information items connected forward with the nodes composing the trie by referring to a required retrieval time of the index information, and store the calculated required retrieval time of each node in the main storage unit;
determining if the required retrieval time of each of the nodes composing the trie is equal to or less than a predetermined threshold value;
retrieving the nodes with the same parent node from the nodes with the required retrieval time being equal to or less than the predetermined threshold value; and
generating an index layered node by grouping the retrieved nodes as a family with relation to the parent node, generate a first trie in which the nodes to be grouped and the nodes connected forward with those nodes are replaced with the generated index layered node, store the generated first trie in a predetermined area of the main storage unit, store a second trie having the nodes to be grouped and the nodes connected forward with the former nodes in a predetermined area of a secondary storage unit located in the computer, and set a pointer information item that designates a storage area of the second trie to each of the index layered nodes in the first trie.

7. The trie generating program as claimed in claim 6 further comprising:
calculating a total of sizes of index information items connected forward with the nodes composing the trie by referring to the sizes of the index information items stored in the secondary storage unit and storing the calculated sizes of the index information items of each node in the main storage unit;
determining if the size of the index information of each of the nodes composing the trie is equal to or less than a predetermined threshold value;
and generating the index layered node by selecting the nodes with the size of the index information item being equal to or less than the predetermined threshold value and grouping the selected nodes as a family with relation to the same parent node.

8. A retrieving program of causing a computer to execute the process of retrieving the index information through the use of the first and the second tries generated by the trie generating program as claimed in claim 6, comprising the steps of causing the computer to accept an input of a term to be retrieved, divide the inputted retrieval term into symbol strings each length of which is equal to or less than a predetermined length, about each divided symbol string, trace the first trie stored in the main storage unit, read a pointer information item set to the end node of the first trie, access the second stored in the second storage unit based on the read pointer information item, trace the accessed second trie, read an index information item designated by the pointer information item set to the end node of the second trie, about each divided symbol string, read location information having a document including the concerned symbol string and a symbol location of the symbol string in the document, retrieve location information in which the divided symbol strings are in the same locational relation with the range of the terms to be retrieved, and output the retrieved location information.

9. A device for generating a trie in which symbol strings of index items of index information are arranged in a tree structure composed of symbol nodes, comprising:
a trie initializing unit for generating the trie, storing the generated trie in a main storage unit, calculating a total of required retrieval times of index information items connected forward with the nodes composing the trie by referring to the required retrieval time of the index information, and storing the calculated required retrieval time of each node in the main storage unit;
an index retrieval time comparing unit for determining if the required retrieval time of each of the nodes composing the trie is equal to or less than a predetermined threshold value;
an adjacent partial symbol string retrieving unit for retrieving the nodes with the same parent node, selected from the nodes with the required retrieval time being equal to or less than the predetermined threshold value; and
an index layered node generating unit for generating an index layered node by grouping the retrieved nodes as a family with relation to the parent node, generating a first trie by replacing the nodes to be grouped and the nodes connected forward with the former nodes with the generated index layered node, storing the generated first trie in a predetermined area of the main storage unit, storing a second trie having the nodes to be grouped and the nodes connected forward with the former nodes in a predetermined area of the secondary storage unit, and setting a pointer information item that designates a storage area of the second trie to the index layered node in the first trie.

10. The trie generating device as claimed in claim 9, further comprising:
an index information size comparing unit for determining if the size of the index information of each of the nodes composing the trie is equal to or less than the predetermined threshold value, and wherein the trie initializing unit stores the generated trie in the main storage unit, calculates a total of the sizes of the index information items connected forward with the nodes composing the trie by referring to the size of the index information, and stores the calculated size of the index information item of each node in the main storage unit, and
the adjacent partial symbol string retrieving unit retrieves the nodes with the same parent node from the nodes with the required retrieval time being equal to or less than the predetermined threshold value.

11. The retrieving device for retrieving the index information through the use of the first and the second tires generated by the trie generating unit as claimed in claim 9, comprising:
an input unit for accepting an input of a retrieval term;
an index retrieving unit for dividing the inputted retrieval term into a symbol string the length of which is equal to or less than a predetermined length, about each of the divided symbol strings, tracing the first trie stored in the main storage unit, reading a pointer information item set to the end node of the first trie, accessing the second trie stored in the secondary storage unit based on the read pointer information item, tracing the nodes of the accessed second trie, reading the index information item designated by the pointer information item set to the end node of the second trie, about each of the divided symbol strings, reading a location information item having a document including a concerned divided symbol string and a symbol location of the concerned symbol string, and retrieving the location information item in which the divided symbol strings are in the same locational relation with the range of the terms to be retrieved, and
an output unit for outputting the retrieved location information item.
